(19) United States
(12) Patent Application Publication
(10) Pub. No.: US 2026/0367273 A1
(43) Pub. Date: Nov. 19, 2026

(54) IDENTIFICATION DEVICE, IDENTIFICATION METHOD, AND NON-TRANSITORY COMPUTER-READABLE MEDIUM

(71) Applicant: NEC Corporation, Tokyo (JP)

(72) Inventors: Masato YOSHIOKA, Tokyo (JP); Koji mizuguchi, Tokyo (JP)

(73) Assignee: NEC Corporation, Tokyo (JP)

(21) Appl. No.: 19/660,500

(22) Filed: Apr. 28, 2026

(30) Foreign Application Priority Data
May 15, 2025 (JP) 2025-081634

(51) Int. Cl. G01V 1/50; E21B 41/00; E21B 47/117; G01V 1/22

(52) U.S. Cl. CPC G01V 1/50; E21B 41/0057; E21B 47/117; G01V 1/226; G01V 2210/624; G01V 2210/74

(57) ABSTRACT

An identification device according to the present disclosure includes at least one memory that stores instructions, and at least one processor configured to execute the instructions to receive first backscattered light from a first optical fiber laid along an injection well for injecting gas into an underground reservoir, the first backscattered light including information regarding vibration, receive second backscattered light from a second optical fiber laid along a ground, the second backscattered light including information regarding the vibration, identify a generation position of the vibration based on the first backscattered light and the second backscattered light, and determine whether the vibration is generated due to injection of the gas into the reservoir based on a generation position of the vibration.

### INCORPORATION BY REFERENCE

This application is based upon and claims the benefit of priority from Japanese patent application No. 2025-081634, filed on May 15, 2025, the disclosure of which is incorporated herein in its entirety by reference.

### TECHNICAL FIELD

The present disclosure relates to an identification device, an identification method, and a non-transitory computer-readable medium.

### BACKGROUND ART

In recent years, attention has been paid to a technology called Carbon dioxide Capture and Storage (CCS) in which carbon dioxide generated by resource development or the like is collected, and the collected carbon dioxide is injected and stored in an underground reservoir through an injection well.

Reduction in the emission amount of carbon dioxide into the atmosphere is expected by storing carbon dioxide in the underground by the CCS. On the other hand, injecting carbon dioxide into the underground generates a small vibration in the underground, and this vibration may adversely affect the underground (e.g., large-scale stratum shift etc.). Therefore, the CCS operator needs to monitor the vibration caused by the injection of carbon dioxide into the reservoir for a long period of time in real time.

Here, examples of a related technology for monitoring vibration generated in the underground include a technology using an Ocean Bottom Seismograph (OBS), a hydrophone, a piezoelectric transducer, downhole observation equipment, and the like. However, all of these related technologies have high monitoring costs. Therefore, if monitoring of long period of time is performed by these related technologies, there is a concern that the economic efficiency of the CCS business will be greatly reduced.

On the other hand, in recent years, a technology called optical fiber sensing represented by Distributed Acoustic Sensing (DAS) has attracted attention. Since the optical fiber sensing uses an optical fiber laid on the ocean bottom or the like as a sensor, it is possible to perform monitoring at low cost as compared with the related art described above. For example, JP 2023-080150 A discloses a technology for detecting self-excited vibration generated in the sea by an optical fiber disposed on the ocean bottom.

### SUMMARY

Meanwhile, in the underground, various vibrations (e.g., a naturally occurring earthquake etc.) are generated other than the vibrations caused by the injection of carbon dioxide into the reservoir.

However, since the technology disclosed in JP 2023-080150 A is merely a technology for detecting self-excited vibration generated in the sea, even if vibration generated in the underground can be detected, it is difficult to identify whether the vibration is vibration caused by the injection of carbon dioxide into the reservoir.

Therefore, in view of the above-described problems, an example object of the present disclosure is to provide an identification device, an identification method, and a non-transitory computer-readable medium capable of identifying vibration caused by injection of carbon dioxide into a reservoir.

An identification device according to one example aspect includes
at least one memory that stores instructions, and
at least one processor configured to execute the instructions to
receive first backscattered light from a first optical fiber laid along an injection well for injecting gas into an underground reservoir, the first backscattered light including information regarding vibration,
receive second backscattered light from a second optical fiber laid along a ground, the second backscattered light including information regarding the vibration,
identify a generation position of the vibration based on the first backscattered light and the second backscattered light, and
determine whether the vibration is generated due to injection of the gas into the reservoir based on a generation position of the vibration.

An identification method according to one example aspect is
an identification method executed by an identification device, the identification method including
receiving first backscattered light from a first optical fiber laid along an injection well for injecting gas into an underground reservoir, the first backscattered light including information regarding vibration,
receiving second backscattered light from a second optical fiber laid along a ground, the second backscattered light including information regarding the vibration,
identifying a generation position of the vibration based on the first backscattered light and the second backscattered light, and
determining whether the vibration is generated due to injection of the gas into the reservoir based on a generation position of the vibration.

A non-transitory computer-readable medium according to one example aspect stores a program for causing a computer to execute procedures including
receiving first backscattered light from a first optical fiber laid along an injection well for injecting gas into an underground reservoir, the first backscattered light including information regarding vibration,
receiving second backscattered light from a second optical fiber laid along a ground, the second backscattered light including information regarding the vibration,
identifying a generation position of the vibration based on the first backscattered light and the second backscattered light, and
determining whether the vibration is generated due to injection of the gas into the reservoir based on a generation position of the vibration.

According to the above aspect, an effect is obtained in that an identification device, an identification method, and a non-transitory computer-readable medium capable of identifying vibration caused by injection of carbon dioxide into a reservoir can be provided.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram illustrating a laying example of optical fibers according to the present disclosure;

FIG. 2 is a block diagram illustrating a configuration example of an identification device according to the present disclosure;

FIG. 3 is a diagram for explaining an example of an identification method of a generation position of the vibration by an identification unit according to the present disclosure;

FIG. 4 is a diagram for explaining an example of the identification method of the generation position of the vibration by the identification unit according to the present disclosure;

FIG. 5 is a diagram for explaining an example of the identification method of the generation position of the vibration by the identification unit according to the present disclosure;

FIG. 6 is a diagram for explaining an example of the identification method of the generation position of the vibration by the identification unit according to the present disclosure;

FIG. 7 is a flowchart for explaining an example of an operation flow of the identification device according to the present disclosure;

FIG. 8 is a block diagram illustrating a configuration example of an identification device according to the present disclosure;

FIG. 9 is a diagram for explaining an example of a method for estimating a carbon dioxide leakage spot by an estimation unit according to the present disclosure;

FIG. 10 is a flowchart for explaining an example of an operation flow of the identification device according to the present disclosure;

FIG. 11 is a block diagram illustrating a configuration example of an identification device according to the present disclosure;

FIG. 12 is a flowchart for explaining an example of an operation flow of the identification device according to the present disclosure;

FIG. 13 is a block diagram illustrating a configuration example of an identification device according to the present disclosure; and

FIG. 14 is a block diagram illustrating a hardware configuration example of a computer that implements the identification device according to the present disclosure.

### EXAMPLE EMBODIMENTS

Hereinafter, example embodiments of the present disclosure will be described below with reference to the drawings. The following description and drawings are omitted and simplified as appropriate for clarity of description. In the following drawings, the same elements are denoted by the same reference signs, and redundant description will be omitted as necessary.

### FIRST EXAMPLE EMBODIMENT

The first example embodiment is an example in which carbon dioxide is injected into an underground reservoir, but the present disclosure is not limited thereto, and may be applied to an example in which another gas is injected into a reservoir. In addition, the first example embodiment is an example in which carbon dioxide is injected into the reservoir from the seabed, but the present disclosure is not limited thereto, and may be applied to an example in which carbon dioxide is injected into the reservoir from the ground surface on the ground.

First, a laying example of optical fibers 21 and 31 according to the present disclosure will be described.

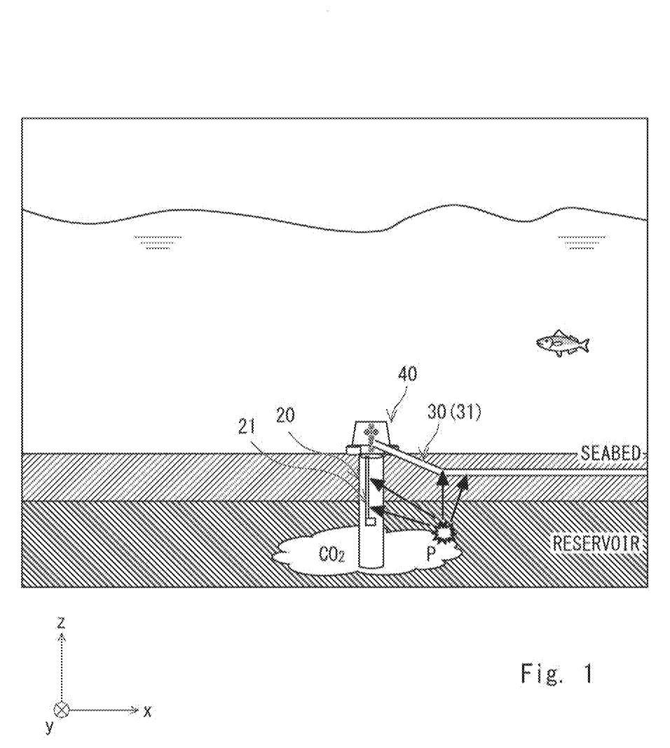

FIG. 1 is a diagram illustrating a laying example of optical fibers 21 and 31 according to the present disclosure.

As illustrated in FIG. 1, an injection well 20 is dug in the vertical direction from the seabed to reach an underground reservoir. Therefore, carbon dioxide generated by resource development or the like is injected into the reservoir from the seabed via the injection well 20 and stored in the reservoir. Furthermore, in the injection well 20, an optical fiber 21 for DAS-Vertical Seismic Profiling (VSP) is laid along the inside of the injection well 20. In this manner, the optical fiber 21 is laid in the z-axis direction along the inside of the injection well 20.

In addition, well head equipment 40 for controlling the injection well 20 at the time of emergency such as a blowout is installed on the seabed. Furthermore, the well head equipment 40 is connected to a ground facility (not illustrated) by a power supply cable 30 laid along the seabed. Specifically, the power supply cable 30 is buried at a depth of about 1 m from the seabed. In addition, the optical fiber 31 is included in the power supply cable 30. As a result, the ground facility can supply power to the well head equipment 40 and remotely operate the well head equipment 40. As described above, the optical fiber 31 included in the power supply cable 30 is laid in the xy plane direction along the seabed.

In the present disclosure, vibration reception data is obtained by optical fiber sensing using the optical fiber 21 laid along the inside of the injection well 20. In addition, vibration reception data is obtained by optical fiber sensing using the optical fiber 31 laid along the seabed. Then, by integrating the vibration reception data obtained by the optical fiber 21 and the vibration reception data obtained by the optical fiber 31, the vibration generated around the injection well 20 is detected and the generation position P of the vibration is identified.

Subsequently, a configuration of an identification device 10 according to the present disclosure will be described.

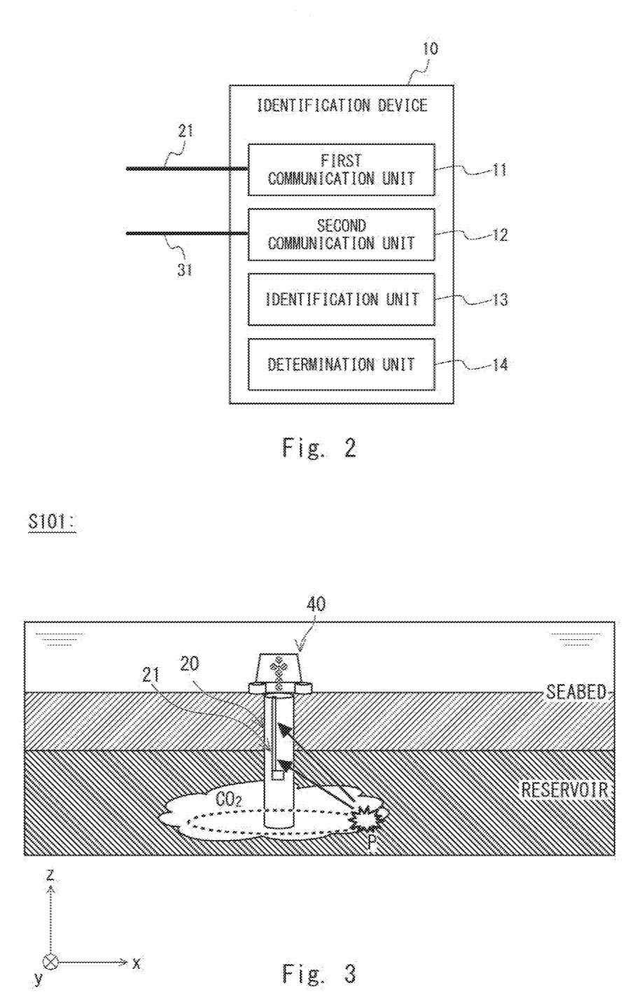

FIG. 2 is a block diagram illustrating a configuration example of the identification device 10 according to the present disclosure. The identification device 10 is installed, for example, inside the well head equipment 40. However, the installation position of the identification device 10 is not limited thereto.

As illustrated in FIG. 2, the identification device 10 includes a first communication unit 11, a second communication unit 12, an identification unit 13, and a determination unit 14.

The first communication unit 11 is connected to the optical fiber 21 laid along the inside of the injection well 20. The first communication unit 11 transmits pulsed light to the optical fiber 21. Then, as the pulsed light is transmitted through the optical fiber 21, backscattered light is generated. The first communication unit 11 receives the backscattered light from the optical fiber 21.

If vibration is generated around the injection well 20, the vibration reaches an arbitrary point on the optical fiber 21, and characteristics (e.g., wavelength) of backscattered light generated at the point change. Thus, it can be said that the backscattered light received from the optical fiber 21 includes information regarding the vibration generated around the injection well 20.

In addition, in a case where the characteristics of the backscattered light received from the optical fiber 21 change, the identification unit 13 can determine that the vibration generated around the injection well 20 is observed at the point on the optical fiber 21 where the backscattering has occurred.

Furthermore, the identification unit 13 can identify a position of a point on the optical fiber 21 where the backscattered light is generated (a distance on the optical fiber 21 from the first communication unit 11) based on a time difference between a time at which the pulsed light has been transmitted to the optical fiber 21 and a time at which the backscattered light has been received from the optical fiber 21.

Therefore, the identification unit 13 can identify the position of the observation point where the vibration generated around the injection well 20 is observed among the points on the optical fiber 21 (the distance of the optical fiber 21 from the first communication unit 11) based on the backscattered light received from the optical fiber 21. Furthermore, the identification unit 13 can identify the time at which the backscattered light is generated as an observation time at which the vibration is observed at the observation point.

As described above, the identification unit 13 can identify an observation point at which the vibration generated around the injection well 20 is observed among the points on the optical fiber 21 based on the backscattered light received from the optical fiber 21. In addition, for each observation point, the identification unit 13 can obtain vibration reception data indicating the position of the observation point (the distance of the optical fiber 21 from the first communication unit 11) and the observation time at which the vibration is observed at the observation point. It is assumed that the identification unit 13 holds information regarding the latitude and longitude of the injection well 20 (i.e., the optical fiber 21) in advance.

The second communication unit 12 is connected to the optical fiber 31 laid along the seabed. The second communication unit 12 transmits pulsed light to the optical fiber 31, and receives, from the optical fiber 31, backscattered light generated accompanying the transmission of the pulsed light through the optical fiber 31.

If vibration is generated around the injection well 20, the vibration reaches an arbitrary point on the optical fiber 31, and characteristics (e.g., wavelength) of backscattered light generated at the point change.

Therefore, the identification unit 13 can identify an observation point at which the vibration generated around the injection well 20 is observed among the points on the optical fiber 31 based on the backscattered light received from the optical fiber 31.

In addition, for each of the observation points identified above based on the backscattered light received from the optical fiber 31, the identification unit 13 can obtain vibration reception data indicating the position of the observation point (the distance of the optical fiber 31 from the second communication unit 12) and the observation time at which the vibration is observed at the observation point. The identification unit 13 holds in advance, for every point on the optical fiber 31, a correspondence table indicating the position of the point (the distance of the optical fiber 31 from the second communication unit 12) and the latitude and longitude of the point. Therefore, in a case where the identification unit 13 identifies an observation point on the optical fiber 31 based on the backscattered light received from the optical fiber 31, it is assumed that the latitude and longitude of the observation point can be identified by verifying the position where the backscattered light is generated with the correspondence table.

Then, the identification unit 13 identifies the generation position P of the vibration generated around the injection well 20 based on the vibration reception data obtained by the optical fiber 21 and the vibration reception data obtained by the optical fiber 31. An identification method of the generation position P of the vibration will be described later.

The determination unit 14 determines, based on the generation position P of the vibration generated around the injection well 20 identified by the identification unit 13, whether the vibration is generated due to the injection of carbon dioxide into the reservoir.

For example, if a two-dimensional distance in the xy coordinate system or a three-dimensional distance in the xyz coordinate system between the position of the injection well 20 and the generation position P of the vibration is equal to or less than a predetermined threshold value, the determination unit 14 may determine that the vibration is generated due to the injection of carbon dioxide into the reservoir.

In a case of determining that the vibration generated around the injection well 20 is generated due to the injection of carbon dioxide into the reservoir, the determination unit 14 may issue a warning together with information such as the injection pressure of carbon dioxide, the injection amount, and the temperature inside the injection well 20 before and after the generation of the vibration.

Here, an identification method of the generation position P of the vibration by the identification unit 13 according to the present disclosure will be described in detail.

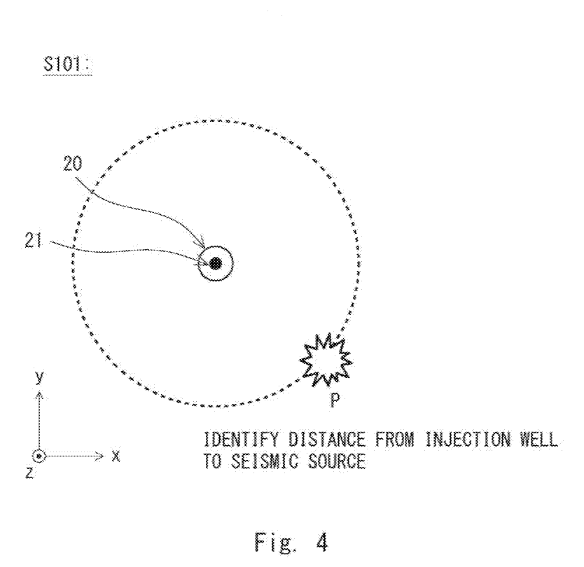

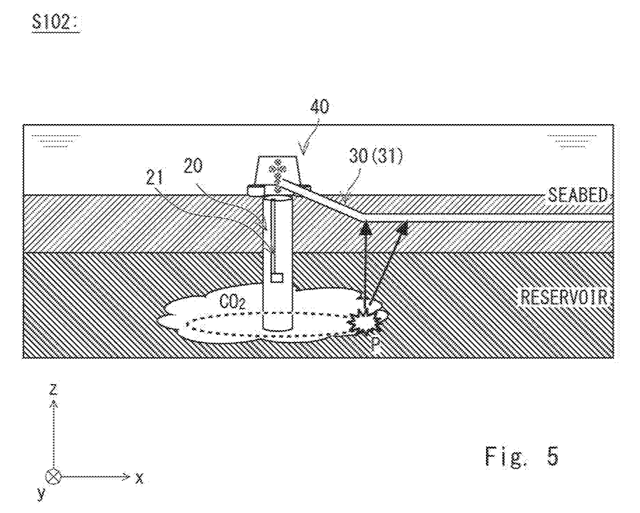

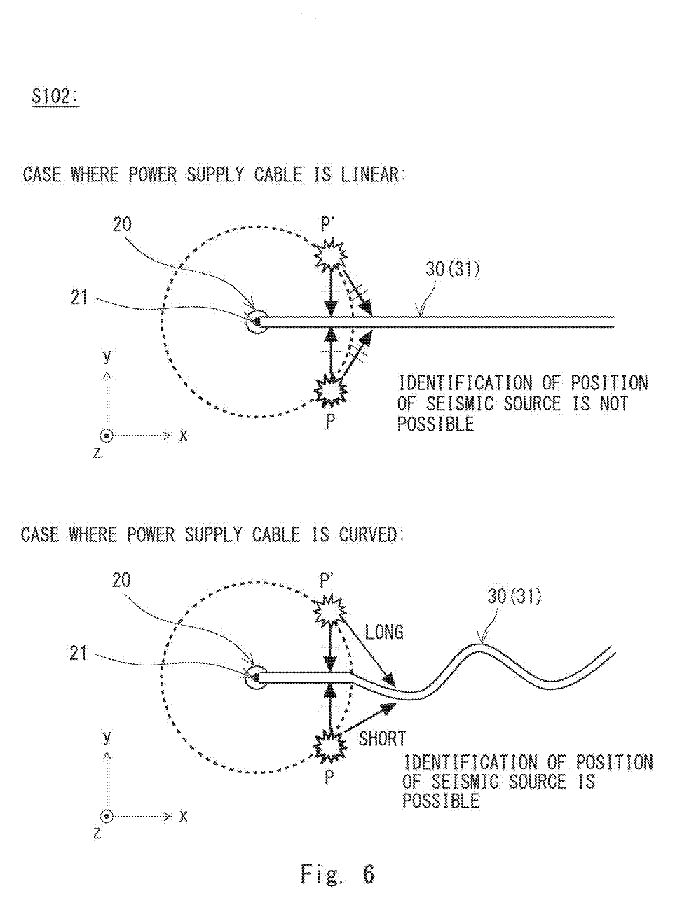

FIGS. 3 - 6 are diagrams for explaining an example of the identification method of the generation position P of the vibration by the identification unit 13 according to the present disclosure; Among these, FIG. 4 corresponds to a plan view of FIG. 3 as viewed from above, and FIG. 6 corresponds to a plan view of FIG. 5 as viewed from above. Furthermore, in FIGS. 3 and 4, the power supply cable 30 is omitted, and in FIGS. 4 and 6, the well head equipment 40 is omitted.

### Step S101

In step S101, the identification unit 13 uses the vibration reception data obtained by the optical fiber 21 laid along the inside of the injection well 20.

As illustrated in FIGS. 3 and 4, first, the identification unit 13 selects two or more observation points at which the vibration generated around the injection well 20 is observed among the points on the optical fiber 21.

Next, the identification unit 13 identifies the distance from the center of the injection well 20 to the generation position P of the vibration in the xy plane by using the positions of two or more observation points on the optical fiber 21 (the distance of the optical fiber 21 from the first communication unit 11) and the observation time of the vibration at the two or more observation points. At this time point, the candidates for the position in the xy plane direction of the generation position P are narrowed down to any position on the circle separated from the center of the injection well 20 by the distance identified above.

In addition, the identification unit 13 identifies the position of the generation position P of the vibration in the z-axis direction by using the positions of two or more observation points on the optical fiber 21 (the distance of the optical fiber 21 from the first communication unit 11) and the observation time of the vibration at the two or more observation points.

### Step S102

In step S102, the identification unit 13 uses the vibration reception data obtained by the optical fiber 31 laid along the seabed.

FIG. 6 illustrates an example in which the power supply cable 30 is linear and an example in which the power supply cable 30 is curved.

In a case where the power supply cable 30 is linear, at each point on the optical fiber 31 included in the power supply cable 30, the distance with the generation position P of the vibration and the distance with the position P' line symmetric to the generation position P are the same distances, so that the generation position P and the position P' cannot be distinguished from each other.

On the other hand, in a case where the power supply cable 30 is curved, at each point on the optical fiber 31, the distance with the generation position P of the vibration and the distance with the position P' are different distances, so that the generation position P and the position P' can be distinguished from each other.

Therefore, the power supply cable 30 is laid in a curved shape on the xy plane. On this assumption, the identification unit 13 performs the following operation.

As illustrated in FIGS. 5 and 6, the identification unit 13 first selects two or more observation points at which vibrations generated around the injection well 20 are observed and are arranged on the curved portion of the optical fiber 31, among the points on the optical fiber 31.

Next, the identification unit 13 converts the positions of two or more observation points on the optical fiber 31 (distances of the optical fiber 31 from the second communication unit 12) into latitude and longitude using the correspondence table described above.

Next, the identification unit 13 identifies the position of the generation position P of the vibration in the xy plane direction by using the distance from the center of the injection well 20 identified in step S101, the latitude and longitude of two or more observation points on the optical fiber 31, and the observation time of the vibration at the two or more observation points.

Subsequently, an example of an operation flow of the identification device 10 according to the present disclosure will be described.

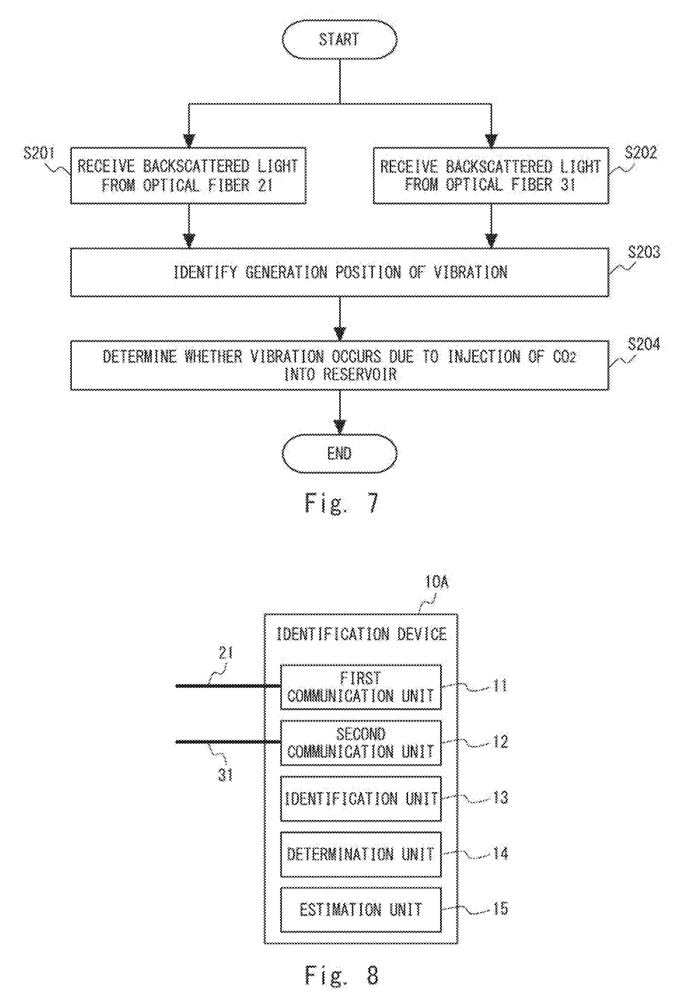

FIG. 7 is a flowchart for explaining an example of the operation flow of the identification device 10 according to the present disclosure.

As illustrated in FIG. 7, the first communication unit 11 transmits pulsed light to the optical fiber 21 laid along the inside of the injection well 20, and receives backscattered light generated accompanying the transmission of the pulsed light through the optical fiber 21 from the optical fiber 21 (step S201). On the other hand, the second communication unit 12 transmits pulsed light to the optical fiber 31 laid along the seabed, and receives backscattered light generated accompanying the transmission of the pulsed light through the optical fiber 31 from the optical fiber 31 (step S202). The processing in steps S201 and S202 is performed in parallel.

Next, the identification unit 13 obtains vibration reception data based on the backscattered light received from the optical fiber 21, and obtains vibration reception data based on the backscattered light received from the optical fiber 31. Then, the identification unit 13 identifies the generation position P of the vibration generated around the injection well 20 based on the vibration reception data obtained by the optical fiber 21 and the vibration reception data obtained by the optical fiber 31 (step S203).

Thereafter, the determination unit 14 determines whether the vibration is generated due to the injection of carbon dioxide into the reservoir based on the generation position P of the vibration generated around the injection well 20 (step S204).

As described above, according to the first example embodiment, the first communication unit 11 receives backscattered light from the optical fiber 21 laid along the inside of the injection well 20, and the second communication unit 12 receives backscattered light from the optical fiber 31 laid along the seabed. The identification unit 13 identifies the generation position P of the vibration generated around the injection well 20 based on the backscattered light received from the optical fiber 21 and the backscattered light received from the optical fiber 31. The determination unit 14 determines whether the vibration is generated due to the injection of carbon dioxide into the reservoir based on the generation position P of the vibration. As a result, it becomes possible to identify vibration caused by the injection of carbon dioxide into the reservoir.

In addition, according to the first example embodiment, the existing optical fiber 21 for DAS-VSP laid along the inside of the injection well 20 is used, and the existing optical fiber 31 included in the power supply cable 30 laid along the seabed is used. As a result, it is not necessary to lay and maintain a new optical fiber dedicated to monitoring the vibration generated around the injection well 20, so that the monitoring cost can be greatly reduced.

### SECOND EXAMPLE EMBODIMENT

First, a configuration example of an identification device 10A according to the present disclosure will be described.

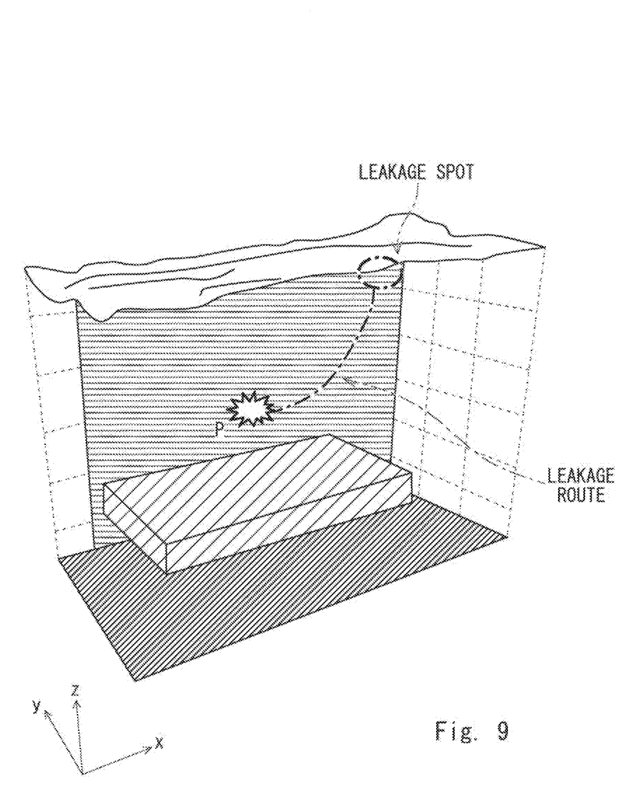

FIG. 8 is a block diagram illustrating a configuration example of the identification device 10A according to the present disclosure.

As illustrated in FIG. 8, the identification device 10A is different from the identification device 10 described above in that an estimation unit 15 is added.

The estimation unit 15 holds, in advance, a three-dimensional geophysical exploration image that is an image showing an underground structure including a reservoir near the injection well 20. For example, a three-dimensional geophysical exploration image can be obtained by a three-dimensional geophysical exploration ship.

In a case where the determination unit 14 determines that the vibration is generated around the injection well 20 due to the injection of the carbon dioxide into the reservoir, the estimation unit 15 estimates the leakage spot where the carbon dioxide leaks from the seabed based on the three-dimensional geophysical exploration image held in advance and the generation position P of the vibration.

Here, a method for estimating a carbon dioxide leakage spot by the estimation unit 15 according to the present disclosure will be described in detail.

FIG. 9 is a diagram for explaining an example of a method for estimating a carbon dioxide leakage spot by the estimation unit 15 according to the present disclosure.

As illustrated in FIG. 9, first, the estimation unit 15 superimposes the generation position P of the vibration generated around the injection well 20 on the three-dimensional geophysical exploration image held in advance. Next, the estimation unit 15 assumes that a crack forms at the generation position P of the vibration and carbon dioxide leaks from the crack, and estimates a leakage route through which the carbon dioxide leaked from the crack flows from the state of the fault near the reservoir. Thereafter, the estimation unit 15 estimates a leakage spot where carbon dioxide flowing through the leakage route leaks from the seabed from the estimated leakage route.

Next, an example of an operation flow of the identification device 10A according to the present disclosure will be described.

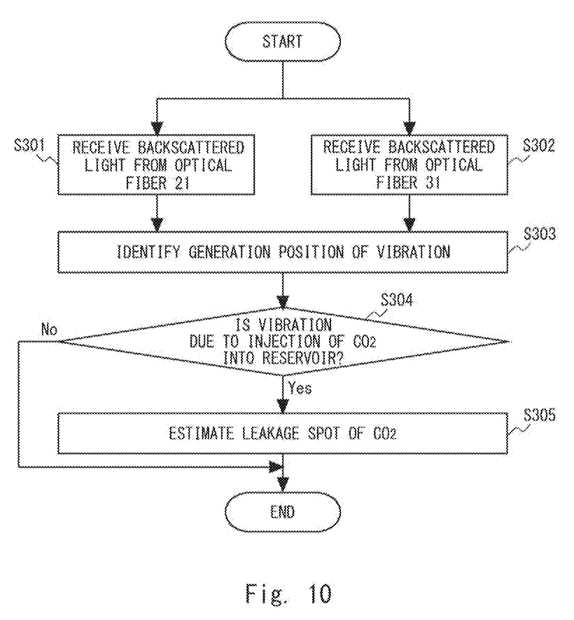

FIG. 10 is a flowchart for explaining an example of the operation flow of the identification device 10A according to the present disclosure. In the example of FIG. 10, it is assumed that the estimation unit 15 already holds a three-dimensional geophysical exploration image showing an underground structure including a reservoir near the injection well 20.

As illustrated in FIG. 10, first, the processing of steps S301 to S303 similar to steps S201 to S203 of FIG. 7 is performed.

Thereafter, the determination unit 14 determines whether the vibration is generated due to the injection of carbon dioxide into the reservoir based on the generation position P of the vibration generated around the injection well 20 (step S304).

In a case where it is determined that the vibration is caused by injection of carbon dioxide into the reservoir in step S304 (Yes in step S304), the estimation unit 15 estimates a leakage spot where carbon dioxide leaks from the seabed based on the three-dimensional geophysical exploration image held in advance and the generation position P of the vibration (step S305).

On the other hand, in a case where it is determined in step S304 that the vibration is not caused by the injection of carbon dioxide into the reservoir (No in step S304), the processing ends.

As described above, according to the second example embodiment, in a case where it is determined that vibration is generated around the injection well 20 due to injection of carbon dioxide into the reservoir, the estimation unit 15 estimates the leakage spot where carbon dioxide leaks from the seabed based on the three-dimensional geophysical exploration image held in advance and the generation position P of the vibration. This makes it possible to narrow down leakage spots where there is a risk of carbon dioxide leaking from the vast seabed.

The other effects are similar to the effects according to the first example embodiment described above.

### Third Example Embodiment

First, a configuration of an identification device 10B according to the present disclosure will be described.

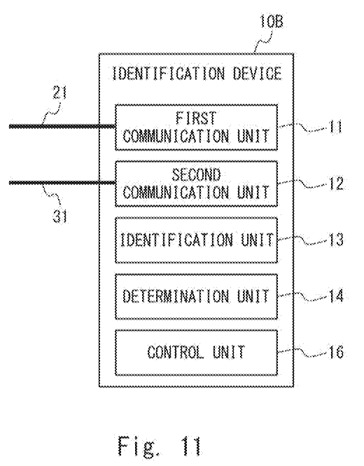

FIG. 11 is a block diagram illustrating a configuration example of the identification device 10B according to the present disclosure.

As illustrated in FIG. 11, the identification device 10B is different from the identification device 10 described above in that a control unit 16 is added.

In a case where the determination unit 14 determines that vibration is generated around the injection well 20 due to the injection of carbon dioxide into the reservoir, the control unit 16 controls the injection amount of carbon dioxide into the reservoir if the number of times of generation of vibration determined to be caused by the injection of carbon dioxide into the reservoir is equal to or greater than a predetermined number of times. For example, the control unit 16 stops the injection of carbon dioxide into the reservoir, depressurizes carbon dioxide, and the like.

Next, an example of an operation flow of the identification device 10B according to the present disclosure will be described.

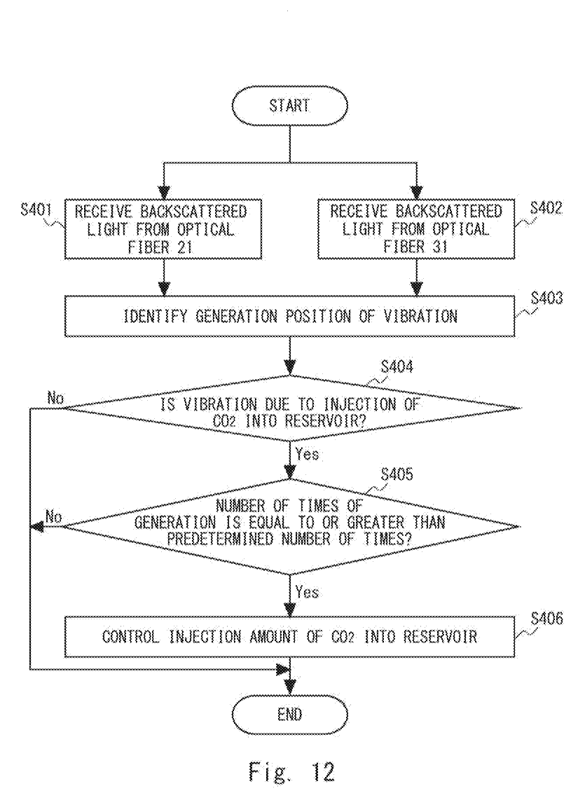

FIG. 12 is a flowchart for explaining an example of an operation flow of the identification device 10B according to the present disclosure.

As illustrated in FIG. 12, first, the processing of steps S401 to S403 similar to steps S201 to S203 of FIG. 7 is performed.

Thereafter, the determination unit 14 determines whether the vibration is generated due to the injection of carbon dioxide into the reservoir based on the generation position P of the vibration generated around the injection well 20 (step S404).

In step S404, in a case where it is determined that the vibration is caused by the injection of carbon dioxide into the reservoir (Yes in step S404), the control unit 16 determines whether the number of times of generation of vibration determined to be caused by the injection of carbon dioxide into the reservoir is equal to or greater than a predetermined number of times (step S405).

In step S405, in a case where the number of times of generation of vibration determined to be caused by the injection of carbon dioxide into the reservoir is equal to or greater than the predetermined number of times (Yes in step S405), the control unit 16 controls the injection amount of carbon dioxide into the reservoir (step S406).

In a case where it is determined that the vibration is not caused by the injection of carbon dioxide into the reservoir in step S404 (No in step S404) and in a case where the number of times of generation of vibration determined to be caused by the injection of carbon dioxide into the reservoir is not equal to or greater than a predetermined number of times in step S405 (Yes in step S405), the processing ends.

As described above, according to the third example embodiment, the control unit 16 controls the injection amount of carbon dioxide into the reservoir in a case where the number of times of generation of vibration determined to be caused by the injection of carbon dioxide into the reservoir is equal to or greater than a predetermined number of times. As a result, it is possible to optimize the injection amount of carbon dioxide into the reservoir and to suppress the generation of vibration caused by the injection of carbon dioxide.

The other effects are similar to the effects according to the first example embodiment described above.

### FOURTH EXAMPLE EMBODIMENT

A fourth example embodiment corresponds to a superordinate example embodiment of the first to third example embodiments described above.

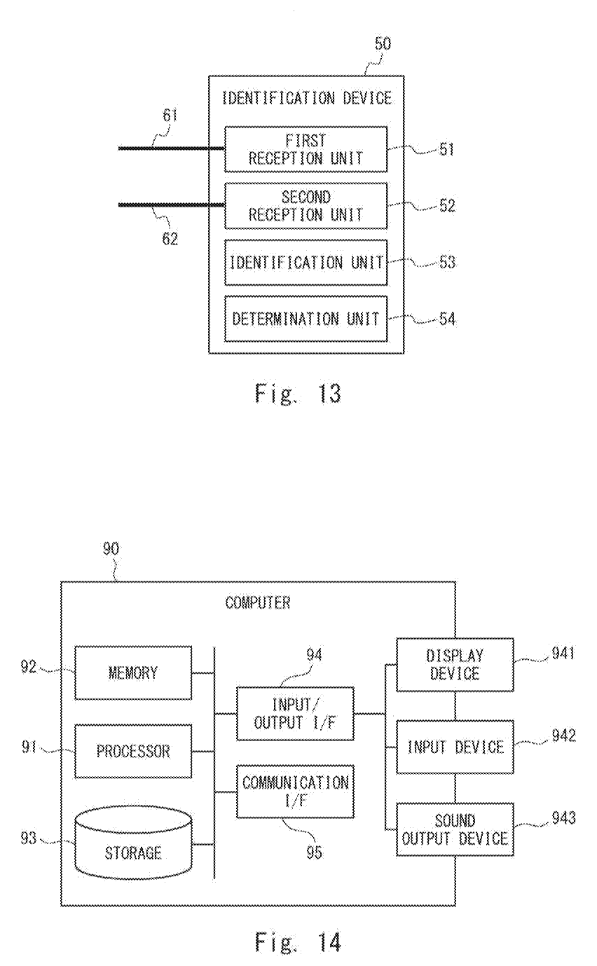

FIG. 13 is a block diagram illustrating a configuration example of the identification device 50 according to the present disclosure.

As illustrated in FIG. 13, the identification device 50 includes a first reception unit 51, a second reception unit 52, an identification unit 53, and a determination unit 54.

The first reception unit 51 receives first backscattered light including vibration information from the first optical fiber 61 laid along the injection well for injecting gas into an underground reservoir.

The second reception unit 52 receives second backscattered light including vibration information from the second optical fiber 62 laid along the ground.

The identification unit 53 identifies the generation position of vibration based on the first backscattered light and the second backscattered light.

Based on the generation position of vibration, the determination unit 54 determines whether the vibration is generated due to the injection of the gas into the reservoir.

Therefore, according to the fourth example embodiment, it is possible to identify the vibration caused by the injection of gas such as carbon dioxide into the reservoir.

The identification device 50 may hold, in advance, a three-dimensional geophysical exploration image indicating an underground structure including a reservoir, and may further include an estimation unit for, in a case where it is determined that the vibration is generated due to the injection of gas into the reservoir, verifying the three-dimensional geophysical exploration image with a generation position of vibration to estimate a leakage spot where the gas leaks from the ground.

In addition, the identification device 50 may further include a control unit for controlling the injection amount of gas into the reservoir in a case where the number of times of generation of vibration determined to be caused by the injection of gas into the reservoir becomes equal to or greater than a predetermined number of times.

In addition, the second optical fiber 62 may be laid in a curved shape along the ground. In addition, the identification unit 53 may identify the generation position of vibration based on the positions of two or more observation points among the observation points at which vibration has been observed on the first optical fiber 61 and the observation times of vibration at the two or more observation points, and the positions of two or more observation points among the observation points at which vibration has been observed on the second optical fiber 62 and the observation times of vibration at the two or more observation points.

In addition, the second optical fiber 62 may be included in a power supply cable that supplies power to a well head equipment that controls the injection well. The gas may be carbon dioxide.

### OTHER EXAMPLE EMBODIMENTS

Although the plurality of components are provided in the identification devices 10, 10A, 10B, and 50 in the first to fourth example embodiments, the present disclosure is not limited to this. In the present disclosure, the plurality of components may be provided in a plurality of devices in a distributed manner. That is, the present disclosure may be achieved by a system including a plurality of devices.

### Hardware Configuration of Identification Device

FIG. 14 is a block diagram illustrating a schematic hardware configuration example of a computer 90 that implements the identification devices 10, 10A, 10B, and 50 according to the present disclosure.

As illustrated in FIG. 14, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage device such as a Hard Disk Drive (HDD), a Solid State Drive (SSD), or a memory card. The storage 93 may be a memory such as the RAM or the ROM.

A program is stored in the storage 93. This program includes instructions (or software code) for causing the computer 90 to perform one or more functions of the identification devices 10, 10A, 10B, and 50 described above in a case where the program is read by the computer. The components in the identification devices 10, 10A, 10B, 50 described above may be implemented by the processor 91 reading and executing a program stored in the storage 93. Furthermore, the storage function in the identification devices 10, 10A, 10B, and 50 described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen relevant to drawing data processed by the processor 91, such as a Liquid Crystal Display (LCD), a Cathode Ray Tube (CRT) display, or a monitor. The input device 942 is a device that receives an operator’s operation input, and is, for example, a keyboard, a mouse, a touch sensor, or the like. The display device 941 and the input device 942 may be integrated and implemented as a touch panel. The sound output device 943 is a device that acoustically outputs a sound associated with acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An identification device including:
at least one memory that stores instructions; and
at least one processor configured to execute the instructions to:
   receive first backscattered light from a first optical fiber laid along an injection well for injecting gas into an underground reservoir, the first backscattered light including information regarding vibration;
   receive second backscattered light from a second optical fiber laid along a ground, the second backscattered light including information regarding the vibration;
   identify a generation position of the vibration based on the first backscattered light and the second backscattered light; and
   determine whether the vibration is generated due to injection of the gas into the reservoir based on a generation position of the vibration.

### Supplementary Note 2

The identification device according to supplementary note 1, in which the at least one processor is configured to execute the instructions to:
hold, in advance, a three-dimensional geophysical exploration image showing an underground structure including the reservoir; and
in a case where it is determined that the vibration is generated due to the injection of the gas into the reservoir, verify the three-dimensional geophysical exploration image with a generation position of the vibration, and estimate a leakage spot where the gas leaks from the ground.

### Supplementary Note 3

The identification device according to supplementary note 1, in which the at least one processor is configured to execute the instructions to control an injection amount of the gas into the reservoir in a case where number of times of generation of the vibration determined to be caused by the injection of the gas into the reservoir becomes equal to or greater than a predetermined number of times.

### Supplementary Note 4

The identification device according to supplementary note 1, in which
the second optical fiber is laid in a curved shape along the ground, and
the at least one processor is configured to execute the instructions to identify the generation position of the vibration based on positions of two or more observation points among the observation points at which the vibration is observed on the first optical fiber and observation times of the vibration at the two or more observation points, and positions of two or more observation points among the observation points at which the vibration is observed on the second optical fiber and observation times of the vibration at the two or more observation points.

### Supplementary Note 5

The identification device according to supplementary note 1, in which the second optical fiber is included in a power supply cable that supplies power to a well head equipment that controls the injection well.

### Supplementary Note 6

The identification device according to supplementary note 1, in which the gas is carbon dioxide.

### Supplementary Note 7

An identification method executed by an identification device, the identification method including:
receiving first backscattered light from a first optical fiber laid along an injection well for injecting gas into an underground reservoir, the first backscattered light including information regarding vibration;
receiving second backscattered light from a second optical fiber laid along a ground, the second backscattered light including information regarding the vibration;
identifying a generation position of the vibration based on the first backscattered light and the second backscattered light; and
determining whether the vibration is generated due to injection of the gas into the reservoir based on a generation position of the vibration.

### Supplementary Note 8

A non-transitory computer-readable medium stored with a program for causing a computer to execute procedures including:
receiving first backscattered light from a first optical fiber laid along an injection well for injecting gas into an underground reservoir, the first backscattered light including information regarding vibration;
receiving second backscattered light from a second optical fiber laid along a ground, the second backscattered light including information regarding the vibration;
identifying a generation position of the vibration based on the first backscattered light and the second backscattered light; and
determining whether the vibration is generated due to injection of the gas into the reservoir based on a generation position of the vibration.

Note that, some or all of elements (e.g., structures and functions) specified in Supplementary Notes 2 to 6 dependent on Supplementary Note 1 may also be dependent on Supplementary Note 7 and Supplementary Note 8 in dependency similar to that of Supplementary Notes 2 to 6 dependent on Supplementary Note 1. Some or all of elements specified in any of Supplementary Notes may be applied to various types of hardware, software, and recording means for recording software, systems, and methods.

What is claimed is:

1. An identification device comprising:
at least one memory that stores instructions; and
at least one processor configured to execute the instructions to:
receive first backscattered light from a first optical fiber laid along an injection well for injecting gas into an underground reservoir, the first backscattered light including information regarding vibration;
receive second backscattered light from a second optical fiber laid along a ground, the second backscattered light including information regarding the vibration;
identify a generation position of the vibration based on the first backscattered light and the second backscattered light; and
determine whether the vibration is generated due to injection of the gas into the reservoir based on a generation position of the vibration.

2. The identification device according to claim 1, wherein the at least one processor is configured to execute the instructions to:
hold, in advance, a three-dimensional geophysical exploration image showing an underground structure including the reservoir; and
in a case where it is determined that the vibration is generated due to the injection of the gas into the reservoir, verify the three-dimensional geophysical exploration image with a generation position of the vibration, and estimate a leakage spot where the gas leaks from the ground.

3. The identification device according to claim 1, wherein the at least one processor is configured to execute the instructions to control an injection amount of the gas into the reservoir in a case where number of times of generation of the vibration determined to be caused by the injection of the gas into the reservoir becomes equal to or greater than a predetermined number of times.

4. The identification device according to claim 1, wherein
the second optical fiber is laid in a curved shape along the ground, and
the at least one processor is configured to execute the instructions to identify the generation position of the vibration based on positions of two or more observation points among the observation points at which the vibration is observed on the first optical fiber and observation times of the vibration at the two or more observation points, and positions of two or more observation points among the observation points at which the vibration is observed on the second optical fiber and observation times of the vibration at the two or more observation points.

5. The identification device according to claim 1, wherein the second optical fiber is included in a power supply cable that supplies power to a well head equipment that controls the injection well.

6. The identification device according to claim 1, wherein the gas is carbon dioxide.

7. An identification method executed by an identification device, the identification method comprising:
receiving first backscattered light from a first optical fiber laid along an injection well for injecting gas into an underground reservoir, the first backscattered light including information regarding vibration;
receiving second backscattered light from a second optical fiber laid along a ground, the second backscattered light including information regarding the vibration;
identifying a generation position of the vibration based on the first backscattered light and the second backscattered light; and
determining whether the vibration is generated due to injection of the gas into the reservoir based on a generation position of the vibration.

8. A non-transitory computer-readable medium stored with a program for causing a computer to execute procedures including:
receiving first backscattered light from a first optical fiber laid along an injection well for injecting gas into an underground reservoir, the first backscattered light including information regarding vibration;
receiving second backscattered light from a second optical fiber laid along a ground, the second backscattered light including information regarding the vibration;
identifying a generation position of the vibration based on the first backscattered light and the second backscattered light; and
determining whether the vibration is generated due to injection of the gas into the reservoir based on a generation position of the vibration.
